(19) United States
(12) Patent Application Publication
(10) Pub. No.: US 2006/0007291 A1
(43) Pub. Date: Jan. 12, 2006

(54) Item printing system

(76) Inventor: Walter Herbert Henson, Essex (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/503,111

(22) PCT Filed: Jan. 31, 2003
(86) PCT No.: PCT/GB03/00392

§ 371 Date: Aug. 10, 2005

(30) Foreign Application Priority Data
Jan. 31, 2002 (GB) 0202203.6

(51) Int. Cl. B41J 2/01

(52) U.S. Cl. 347/104

(57) ABSTRACT

An item printing system for printing imprints on moving items, comprising: an item transport path through which items are in use transported in a transport direction; an item transport unit for transporting items through the item transport path; a printing unit for printing imprints on items transported through the item transport path; a first free roller disposed upstream of the printing unit and driven by respective items transported through the item transport path; a second free roller disposed downstream of the printing unit and driven by respective items transported through the item transport path; a first speed measurement unit for providing an output representative of the speed of rotation of the first free roller; and a second speed measurement unit for providing an output representative of the speed of rotation of the second free roller.

The present invention relates to an item printing system for printing imprints on moving items, in particular a mail printing system for printing indicia on mail items.

In printing systems, driven rollers are usually used to transport the items to be printed, with the driven rollers being driven by drive units, typically dc motors. In practice, there tends to be some variation in the speed of such driven rollers, which can cause the printing of imperfect imprints, particularly where the system includes driven rollers both upstream and downstream of the printing unit.

It is an aim of the present invention to provide an improved item printing system for printing imprints on moving items.

Accordingly, the present invention provides an item printing system for printing imprints on moving items, comprising: an item transport path through which items are in use transported in a transport direction; an item transport unit for transporting items through the item transport path; a printing unit for printing imprints on items transported through the item transport path, a first free roller disposed upstream of the printing unit and driven by respective items transported through the item transport path; a second free roller disposed downstream of the printing unit and driven by respective items transported through the item transport path; a first speed measurement unit for providing an output representative of the speed of rotation of the first free roller; and a second speed measurement unit for providing an output representative of the speed of rotation of the second free roller.

Preferably, the system further comprises: a control unit for controlling rate of printing by the printing unit in response to the output of one of the first and second speed measurement units.

More preferably, the control unit is configured to control rate of printing by the printing unit in response to the output of the first speed measurement unit in a first printing phase and the output of the second speed measurement unit in a second printing phase.

Yet more preferably, the first and second free rollers are disposed such as to be engaged simultaneously by any item for a period of time, such as to enable a relationship between the outputs of the first and second speed measurement units to be determined when the first and second free rollers are commonly driven by the item.

Still yet more preferably, the control unit is configured to control rate of printing by the printing unit in response to the output of the second speed measurement unit on determination of the relationship between the outputs of the first and second speed measurement units.

In one embodiment the first speed measurement unit comprises a first tachometer unit for measuring speed of rotation of the first free roller, the first tachometer unit including an encoder wheel coupled to the first free roller and providing an output representative of the speed of rotation of the first free roller, and the second speed measurement unit comprises a second tachometer unit for measuring speed of rotation of the second free roller, the second tachometer unit including an encoder wheel coupled to the second free roller and providing an output representative of the speed of rotation of the second free roller.

Preferably, the outputs of the first and second tachometer units comprise pulse trains. Preferably, the printing unit comprises first and second print heads spaced in the transport direction.

In one embodiment one or both of the free rollers comprise a fixed roller.

In one embodiment one or both of the free rollers comprise a floating roller biased towards the item transport path.

Preferably, the item transport unit comprises a first drive roller assembly comprising the first free roller and a first driven roller disposed opposite the first free roller, which rollers act to engage an item and transport the same along the item transport path.

In one embodiment the first driven roller comprises a fixed roller.

In another embodiment the first driven roller comprises a floating roller biased towards the first free roller.

More preferably, the item transport unit comprises a second drive roller assembly comprising the second free roller and a second driven roller disposed opposite the second free roller, which rollers act to engage an item and transport the same along the item transport path.

In one embodiment the second driven roller comprises a fixed roller.

In another embodiment the second driven roller comprises a floating roller biased towards the second free roller.

Preferably, the items comprise mail items.

A preferred embodiment of the present invention will now be described hereinbelow by way of example only with reference to the accompanying drawings, in which:

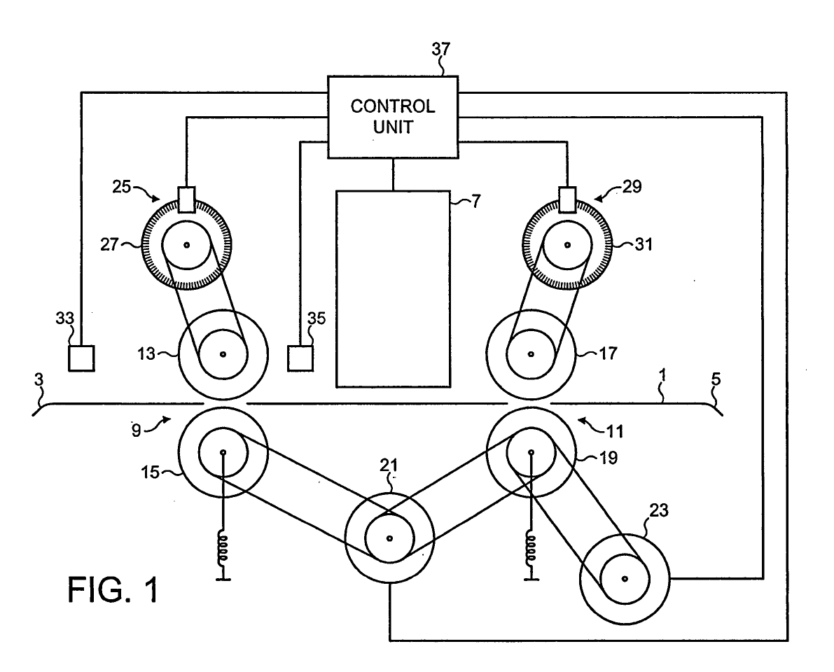

FIG. 1 schematically illustrates a mail printing system in accordance with a preferred embodiment of the present invention; and

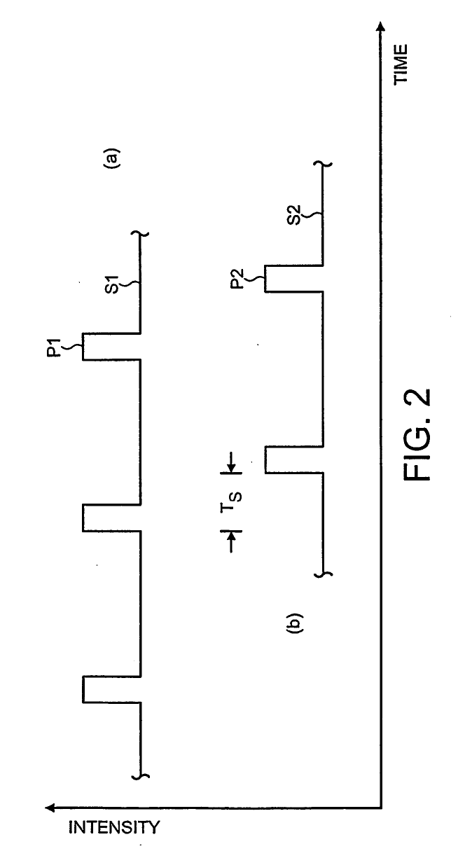

FIG. 2 illustrates output signals for one mail item of the first and second tachometer units of the mail printing system of FIG. 1.

The mail printing system comprises a mail transport path 1, in this embodiment defined by a plate, along which mail items are transported from an inlet end 3 to an outlet end 5.

The mail printing system further comprises a printing unit 7 for printing indicia on mail items transported through the mail transport path 1. In one embodiment the printing unit 7 comprises a single print head. In another embodiment the printing unit 7 comprises first and second print heads, each being configured to print part, preferably half, of an indicium.

The mail printing system further comprises a mail transport unit for transporting mail items through the mail transport path 1, which unit comprises first and second drive roller assemblies 9, 11. In this embodiment the first and second drive roller assemblies 9, 11 are arranged such that the spacing thereof is smaller than the transport dimension of the mail items, that is, the dimension of the mail items in the transport direction, whereby each mail item is commonly driven by both the first and second drive roller assemblies 9, 11 for a period of time in a transition phase between being driven solely by one of the first and second drive roller assemblies 9, 11.

The first drive roller assembly 9 is disposed upstream of the printing unit 7. The first drive roller assembly 9 comprises a first, free idler roller 13, in this embodiment of fixed position, which is disposed to one, in this embodiment the upper, side of the mail transport path 1, and a second, driven roller 15, in this embodiment a floating roller which is biased towards the first, idler roller 13, which rollers 13, 15 act to engage a mail item introduced into the mail transport path 1 and transport the mail item downstream towards the printing unit 7.

The second drive roller assembly 11 is disposed in the mail transport path 1 downstream of the printing unit 7. The second drive roller assembly 11 comprises a first, free idler roller 17, in this embodiment of fixed position, which is disposed to one, in this embodiment the upper, side of the mail transport path 1, and a second, driven roller 19, in this embodiment a floating roller which is biased towards the first, idler roller 17, which rollers 17, 19 act to engage a mail item, the leading edge of which is transported beyond the printing unit 7, and transport the mail item downstream of the printing unit 7 and eject the same from the mail transport path 1.

The mail transport unit further comprises a first drive unit 21, in this embodiment a dc motor, which is coupled to each of the driven rollers 15, 19 of the first and second drive roller assemblies 9, 11 such as to drive the same at a predetermined speed. In this embodiment the first drive unit 21 is coupled by respective belts to the driven rollers 15, 19. In another embodiment the first drive unit 21 could comprise a stepper motor.

The mail transport unit further comprises a second drive unit 23, in this embodiment a de motor, which is coupled to the driven roller 19 of the second drive roller assembly 11 such as to enable the driven roller 19 of the second drive roller assembly 11 to be driven at a speed greater than that of the driven roller 15 of the first drive roller assembly 9. In this embodiment the first and second drive units 21, 23 are coupled to the driven roller 19 of the second drive roller assembly 11 through a clutch arrangement such as to enable the selective operation of the second drive unit 23 to drive the driven roller 19 of the second drive roller assembly 11, and thereby provide for the rapid ejection of mail items from the mail transport path 1. In this embodiment the second drive unit 23 is coupled by a belt to the driven roller 19 of the second drive roller assembly 11. In another embodiment the second drive unit 23 could comprise a stepper motor.

The mail transport system further comprises a first tachometer unit 25 for measuring the speed of rotation of the idler roller 13 of the first drive roller assembly 9, and hence the transport speed of respective mail items introduced to the printing unit 7. The first tachometer unit 25 includes an encoder wheel 27 which is coupled to the idler roller 13 of the first drive roller assembly 9 such as to be driven directly by the mail items passing through the first drive roller assembly 9, with the tachometer unit 25 providing an output signal representative of the speed of rotation of the idler roller 13 of the first drive roller assembly 9, and hence the transport speed of each mail item. FIG. 2(a) illustrates a segment of an output signal S1, as a pulse train, of the first tachometer unit 25 for one mail item, with the frequency of the pulses P1 of the output signal S1 being governed by the pitch of the apertures in the encoder wheel 27. In this embodiment the encoder wheel 27 is coupled by a belt to the idler roller 13 of the first drive roller assembly 9. In another embodiment the encoder wheel 27 could be coupled directly to the shaft of the idler roller 13 of the first drive roller assembly 9.

The mail transport system further comprises a second tachometer unit 29 for measuring the speed of rotation of the idler roller 17 of the second drive roller assembly 11, and hence the transport speed of respective mail items drawn through the printing unit 7. The second tachometer unit 29 includes an encoder wheel 31 which is coupled to the idler roller 17 of the second drive roller assembly 11 such as to be driven directly by the mail items passing through the second drive roller assembly 11, with the tachometer unit 29 providing an output signal representative of the speed of rotation of the idler roller 17 of the second drive roller assembly 11, and hence the transport speed of each mail item. FIG. 2(b) illustrates a segment of an output signal S2, as a pulse train, of the second tachometer unit 29 for the one mail item, with the frequency of the pulses P2 of the output signal S2 being governed by the pitch of the apertures in the encoder wheel 31. In this embodiment the encoder wheels 27, 31 have the same aperture pitch. In other embodiments the encoder wheels 27, 31 could have different aperture pitches. As will be noted from FIGS. 2(a) and (b), the output signals S1, S2 of the first and second tachometer units 25, 29 are not synchronized, as a result of the tachometer units 25, 29 being driven separately; the output signals S1, S2 having a time shift Tₛ. In this embodiment the encoder wheel 31 of the second tachometer unit 29 is coupled by a belt to the idler roller 17 of the second drive roller assembly 11. In another embodiment the encoder wheel 31 of the second tachometer unit 29 could be coupled directly to the shaft of the idler roller 17 of the second drive roller assembly 11.

The mail transport system further comprises a first sensor 33 which is disposed at the inlet end 3 of the mail transport path 1 for sensing the introduction of a mail item thereinto, thereby enabling the actuation of the first and second drive units 21, 23 where those drive units 21, 23 are not already actuated.

The mail transport system further comprises a second sensor 35 which is disposed at a location intermediate the printing unit 7 and the first drive roller assembly 9 for sensing the transport of the leading edge of a mail item to a predetermined location adjacent and upstream of the printing unit 7, thereby providing a timing reference for the subsequent actuation of the printing unit 7 in printing an indicium on the mail item.

The mail transport system further comprises a control unit 37 for receiving the output signals S1, S2 of the first and second tachometer units 25, 29 and the output signals of the first and second sensors 33, 35, and controlling the printing unit 7 and the first and second drive units 21, 23 in response thereto. In this embodiment the control unit 37 is configured to control the rate of printing of the printing unit 7 in response to the measured speed of rotation of one or both of the idler roller 13 of the first drive roller assembly 9 and the idler roller 17 of the second drive roller assembly 11. In this embodiment the indicia are printed line-by-line, with a predetermined number of lines, in one embodiment a single line, being printed in response to the detection of a predetermined number of pulses P1, P2 in the respective one of the output signals S1, S2 of the first and second tachometer units 25, 29. In this way, the rate of printing of indicia is controlled such that indicia are printed on mail items which are of the required size and form, that is, not stretched or compressed as would be achieved by a mail item being transported at too high or too low a speed.

Operation of the above-described mail printing system will now be described hereinbelow.

A mail item is first introduced into the inlet end 3 of the mail transport path 1. The introduction of the mail item into the mail transport path 1 is detected by the first sensor 33. Where the drive units 21, 23 are not already actuated, the control unit 37 is responsive to detection by the first sensor 33 to actuate the drive units 21, 23.

The mail item is then engaged by the first drive roller assembly 9 which acts to transport the mail item downstream along the mail transport path 1 towards the printing unit 7. While the mail item is engaged by the first drive roller assembly 9, the encoder wheel 27 of the first tachometer unit 25 is driven by the idler roller 13 of the first drive roller assembly 9 at a speed corresponding to the transport speed of the mail item.

The second sensor 35 then detects the transport of the leading edge of the mail item beyond a predetermined location upstream of the printing unit 7. The control unit 37 is responsive to detection by the second sensor 35 to actuate the printing unit 7 following transport of the mail item by a predetermined distance, as determined from the output signal S1 of the first tachometer unit 25.

The printing unit 7 prints an indicium line-by-line, with a predetermined number of lines being printed with the detection of a predetermined number of pulses P1 in the output signal S1 of the first tachometer unit 25.

The mail item is then engaged by the second drive roller assembly 11, such that the mail item is commonly engaged by both the first and second drive roller assemblies 9, 11. While the mail item is engaged by both the first and second drive roller assemblies 9, 11, the encoder wheels 27, 31 of the first and second tachometer units 25, 29 are driven by the respective ones of the idler rollers 13, 17 of the first and second drive roller assemblies 9, 11 at a speed corresponding to the transport speed of the mail item.

The control unit 37 is configured to utilize the output signal S2 of the second tachometer unit 29 following transport of the mail item by a predetermined distance downstream of the second sensor 35, the second sensor 35 detecting the location of the leading edge of the mail item at the predetermined location and the output signal S1 of the first tachometer unit 25 being utilized to determine transport over the predetermined distance between the second sensor 35 and the second drive roller assembly 11. As illustrated in FIGS. 2(a) and (b), the output signals S1, S2 of the first and second tachometer units 25, 29 are not synchronized, as the respective encoder wheels 27, 31 are out of phase. In a transition interval, where the mail item is commonly engaged by both the first and second drive roller assemblies 9, 11, the control unit 37 is configured to determine the phase relationship between the output signals S1, S2 of the first and second tachometer units 25, 29 and the association of ones of the pulses P1, P2 of the output signals S1, S2, which association, once determined, enables the output signal S2 of the second tachometer unit 29 to be utilized in controlling the rate of printing by the printing unit 7. With continued transport of the mail item through the mail transport path 1, the mail item is subsequently engaged by only the second drive roller assembly 11. The control unit 37 continues to utilize the output signal S2 of the second tachometer unit 29 to control the printing unit 7.

When printing of the indicium has been completed, the second drive unit 23 is then actuated to drive the driven roller 19 of the second drive roller assembly 11 at a faster speed in order to eject the mail item.

Finally, it will be understood that the present invention has been described in its preferred embodiment and can be modified in many different ways without departing from the scope of the invention as defined by the appended claims.

1. An item printing system for printing imprints on moving items, comprising:
an item transport path through which items are in use transported in a transport direction;
an item transport unit for transporting items through the item transport path;
a printing unit for printing imprints on items transported through the item transport path;
a first free roller disposed upstream of the printing unit and driven by respective items transported through the item transport path;
a second free roller disposed downstream of the printing unit and driven by respective items transported through the item transport path;
a first speed measurement unit for providing an output representative of the speed of rotation of the first free roller; and
a second speed measurement unit for providing an output representative of the speed of rotation of the second free roller.

2. The system of claim 1, further comprising:
a control unit for controlling rate of printing by the printing unit in response to the output of one of the first and second speed measurement units.

3. The system of claim 2, wherein the control unit is configured to control rate of printing by the printing unit in response to the output of the first speed measurement unit in a first printing phase and the output of the second speed measurement unit in a second printing phase.

4. The system of claim 3, wherein the first and second free rollers are disposed such as to be engaged simultaneously by any item for a period of time, such as to enable a relationship between the outputs of the first and second speed measurement units to be determined when the first and second free rollers are commonly driven by the item.

5. The system of claim 4, wherein the control unit is configured to control rate of printing by the printing unit in response to the output of the second speed measurement unit on determination of the relationship between the outputs of the first and second speed measurement units.

6. The system of claim 1, wherein the first speed measurement unit comprises a first tachometer unit for measuring speed of rotation of the first free roller, the first tachometer unit including an encoder wheel coupled to the first free roller and providing an output representative of the speed of rotation of the first free roller, and the second speed measurement unit comprises a second tachometer unit for measuring speed of rotation of the second free roller, the second tachometer unit including an encoder wheel coupled to the second free roller and providing an output representative of the speed of rotation of the second free roller.

7. The system of claim 6, wherein the outputs of the first and second tachometer units comprise pulse trains.

8. The system of claim 1, wherein the printing unit comprises first and second print heads spaced in the transport direction.

9. The system of claim 1, wherein one or both of the free rollers comprise a fixed roller.

10. The system of claim 1, wherein one or both of the free rollers comprise a floating roller biased towards the item transport path.

11. The system of claim 1, wherein the item transport unit comprises a first drive roller assembly comprising the first free roller and a first driven roller disposed opposite the first free roller, which rollers act to engage an item and transport the same along the item transport path.

12. The system of claim 11, wherein the first driven roller comprises a fixed roller.

13. The system of claim 11, wherein the first driven roller comprises a floating roller biased towards the first free roller.

14. The system of claim 11, wherein the item transport unit comprises a second drive roller assembly comprising the second free roller and a second driven roller disposed opposite the second free roller, which rollers act to engage an item and transport the same along the item transport path.

15. The system of claim 14, wherein the second driven roller comprises a fixed roller.

16. The system of claim 14, wherein the second driven roller comprises a floating roller biased towards the second free roller.

17. The system of claim 1, wherein the items comprise mail items.
